(19) United States
(12) Patent Application Publication
(10) Pub. No.: US 2006/0101053 A1
(43) Pub. Date: May 11, 2006

(54) System and method for associating software programs with data files within a computer network

(76) Inventor: Reginal Robert Proctor, San Jose, CA (US)

Correspondence Address: RUBINSTEIN LAW GROUP, PROFESSIONAL CORP;PATENTS, 100 Pine Street, 20th Floor, SAN FRANCISCO, CA, 94111, US

(21) Appl. No.: 10/981,806

(22) Filed: Nov. 5, 2004

(51) Int. Cl. G06F 17/00

(52) U.S. Cl. 707/102

(57) ABSTRACT

The present invention teaches a computer implemented method for associating one or more computer software applications with one or more computer data files on a computer system comprising the acts of: providing a computer system, wherein the computer system includes at least one permanent storage device containing at least a portion of at least one data file containing data; selecting the data file; searching the at least one permanent storage device for one or more computer software applications potentially usable in conjunction with the selected data file, wherein the searching is at least partially responsive to the data; selecting at least one of the one or more computer software applications for use in accessing the data file; and accessing at least a portion of the data file using the at least one selected computer software applications.

### FIELD OF THE INVENTION

This invention relates generally to computer software applications. In particular, this invention relates to a software application for automatically selecting an application appropriate for accessing a desired software file.

### BACKGROUND OF THE INVENTION

The number of executable computer software applications used to open computer data files has been rising rapidly over the last decade. Currently there are dozens of different word processor applications, drawing applications, engineering modeling applications, media players, etc. Further there are many different versions of each of these applications.

The most established methodology for associating desired executable software applications with selected data files is the “File Extension” methodology. This has been used since UNIX, and was adopted for MSDOS and has carried over to the Microsoft Windows operating system. Windows associates data file types with specific applications so that a “double click” on any data file will result in its automatic opening for viewing or modification. File association is one of the benefits of Windows, speeding work habits and increasing productivity.

Associations are stored in the Windows Registry as part of the application installation process. In most cases, the association creation process is automatic, with users not asked about which files will be associated with the new software. When users are aware of file types at all, the knowledge comes through the file extension (the three character designation that follows the “.” in a full file name). These three character labels, e.g. .DOC, .TIF, .HTM, etc., (three is an old standard that developers generally keep to but the file extension can be any reasonable number of characters) are familiar to most computer users, and define the contents of a file as they define the application that will spring into action when the file is double-clicked by a user. The difficulty for applications, and to a lesser extent to users, comes in cases where a single file type can be used by multiple applications.

Windows allows users to have only a single application associated with each extension. The “Open With” application within Windows allows the operating system to associate one extension with one or more programs though user interaction or programmatically.

In the case of applications with multiple versions Windows has an additional shortcoming. Windows cannot automatically tell which version of most programs is appropriate to a selected data file, nor can it associate a particular version of a software application with a particular data file. This is a common problem with documents such as word documents and tax return files, just as two examples. For example, an accountant may have to access several different versions of Turbo Tax, but Windows would be unable to associate the appropriate version of Turbo Tax with an appropriate tax return data file.

Prior Art FIG. 1 shows a simplified flow chart diagram of a conventional windows application method for selecting software applications for opening selected data files in accordance with the prior art at 100. In a step 100, the Windows operating system boots up and provides a standard Windows Graphical User Interface (GUI) displaying files within a computer permanent storage device, or computer network. In step 120, a user locates and double clicks an icon representing a data file such as a document file or a graphic file, or other type of data file. These files may be displayed in folders or on a “desktop” or may have to be called with some other mechanism such as a DOS command.

In step 125 the operating system (whether Windows or OSX, Linux, or other OS application) checks whether the selected data file is associated with a particular software application. This is usually determined by a file suffix. For example .vsd indicates a Microsoft Visio file type.

If an association does exist the process continues to step 130 at which the computer opens the selected data file using the software application indicated by the file name suffix.

If no software application is associated with the data file the operating system will generally display a menu of standard software application programs for accessing data files at a step 140. This is most often accomplished by the “Open With” application within Windows. Generally there is a standard list of executable programs, and as programs are installed in a system they may add themselves to the Open With registry. The user then selects a software application to open the selected data file with at step 150. The user may either select one of the programs listed on the Open With menu, or may browse for or manually type in an appropriate software application.

Finally in step 160 the operating system uses the selected software application to open the selected data file.

There are many limitations of the current Open With type of method for associating data files and software applications. As the above discussion reflects, no prior art resources provide an easy to understand and efficient method for freely associating file types and software applications. Furthermore, no existing technology allows a user to freely select various versions of application software to be used in opening a selected data file. Additionally, no prior art tool can group software applications such that various file types can be freely associated with various software applications.

What is needed is an easy to understand and efficient method for freely associating file types and software applications. Further needed is a technology which allows a user to freely select various versions of application software to be used in opening a selected data file. Additionally needed is a tool that can group software applications such that various file types can be freely associated with various software applications.

### SUMMARY OF THE INVENTION

The present invention provides an easy to understand and efficient method for freely associating file types and software applications. Further provided is a technology which allows a user to freely select various versions of application software to be used in opening a selected data file. Further provided is a tool that can group software applications such that various file types can be freely associated with various software applications.

Briefly, one aspect of the present invention is embodied in a computer implemented method for associating one or more computer software applications with one or more computer data files on a computer system comprising the acts of: providing a computer system, wherein the computer system includes at least one permanent storage device containing at least a portion of at least one data file containing data; selecting the data file; searching the at least one permanent storage device for one or more computer software applications potentially usable in conjunction with the selected data file, wherein the searching is at least partially responsive to the data; selecting at least one of the one or more computer software applications for use in accessing the data file; and accessing at least a portion of the data file using the at least one selected computer software application. In accordance with another embodiment, the data includes file extension information. In accordance with another embodiment, the method further comprises selecting at least one of the one or more computer software applications to be associated with the data file such that the associated software programs will be displayed in response to future attempts to access the data file.

Another embodiment of the present invention teaches A computer implemented method for associating computer data files with computer software applications comprising the acts of: providing a computer system including one or more computer devices, each including one or more microprocessor devices, wherein the computer system includes at least one permanent storage device containing at least a portion of at least one data file containing data indicating a file type; receiving at least one command selecting the data file; displaying one or more computer software applications potentially usable in conjunction with the selected data file; selecting at least one of the one or more computer software applications for association with the file type; and accessing at least a portion of the selected data file using at least one of the selected associated computer software applications. In accordance with one embodiment, further acts comprise assigning a file extension to the selected data file, wherein the file extension indicates an association of the selected data file and at least one first computer software application.

Yet another embodiment of the present invention teaches a computer implemented method for accessing one or more data files comprising the acts of: providing a computer system including one or more computer devices including one or more microprocessor devices, wherein the computer system includes at least one permanent storage device containing at least a portion of at least one data file containing data; receiving at least one command selecting the data file; searching the at least one permanent storage device for one or more software programs potentially usable in conjunction with the selected data file, wherein the searching is at least partially responsive to the data; selecting at least one of the one or more software programs for use in accessing the data file; and accessing at least a portion of the data file using at least one of the software programs.

### BRIEF DESCRIPTION OF THE DRAWINGS

PRIOR ART FIG. 1 shows a simplified flow chart diagram of a conventional windows application method for selecting software applications for opening selected data files in accordance with the prior art;

FIG. 2 shows a simplified flow chart diagram of a process for selecting a software application for use in opening a selected data file in accordance with one embodiment of the present invention;

FIG. 3 shows a simplified flow chart diagram of another process for selecting a software application for use in opening a selected data file in accordance with another embodiment of the present invention;

FIG. 4 shows a simplified flow chart diagram of alternative process for opening a selected data file with a selected software application in accordance with another embodiment of the present invention;

FIG. 5 shows a simplified flow chart diagram of a process for associating selected data file with selected software application in accordance with a preferred embodiment of the present invention;

FIG. 6. illustrates a simplified flow chart diagram of a process for associating selected file extensions with selected software application groups in accordance with a preferred embodiment of the present invention;

FIG. 7 shows a simplified flow chart diagram of a process for associating a desired version of a particular software application for use in opening a selected data file in accordance with one embodiment of the present invention; and

FIG. 8 shows a hierarchical relationship of groupings of applications and extensions in accordance with one embodiment of the present invention.

### DETAILED DESCRIPTION OF THE INVENTION

The present invention provides an easy to understand and efficient method for freely associating file types and software applications. Further provided is a technology which allows a user to freely select various versions of application software to be used in opening a selected data file. Further provided is a tool that can group software applications such that various file types can be freely associated with various software applications.

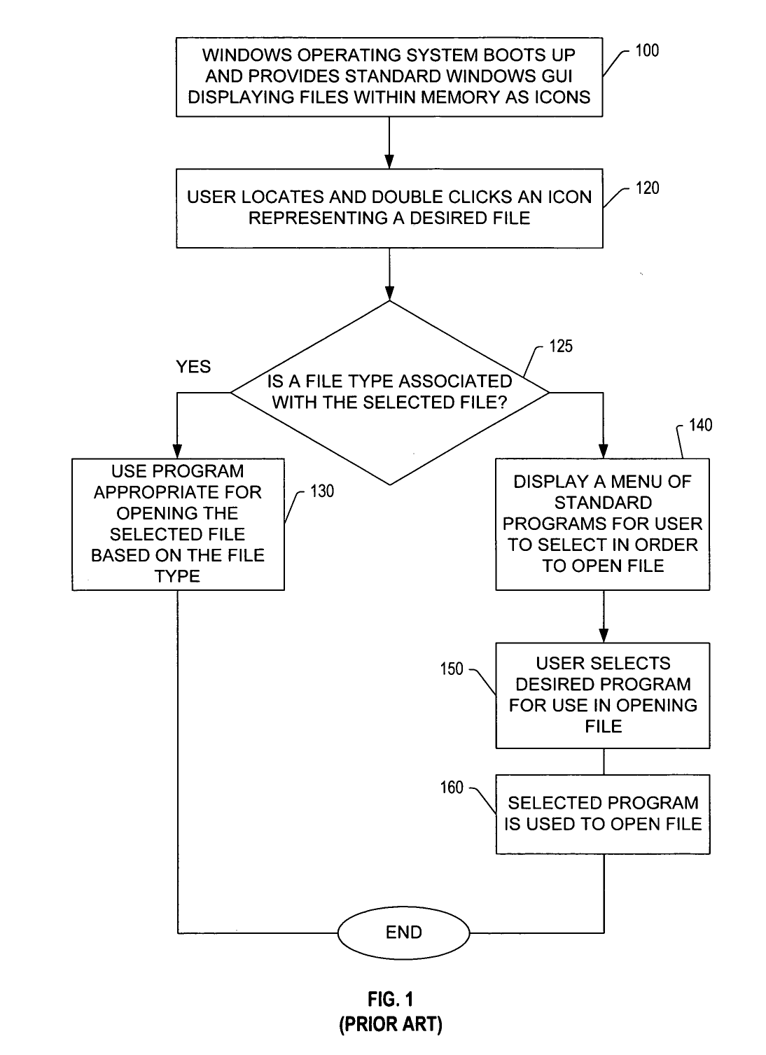

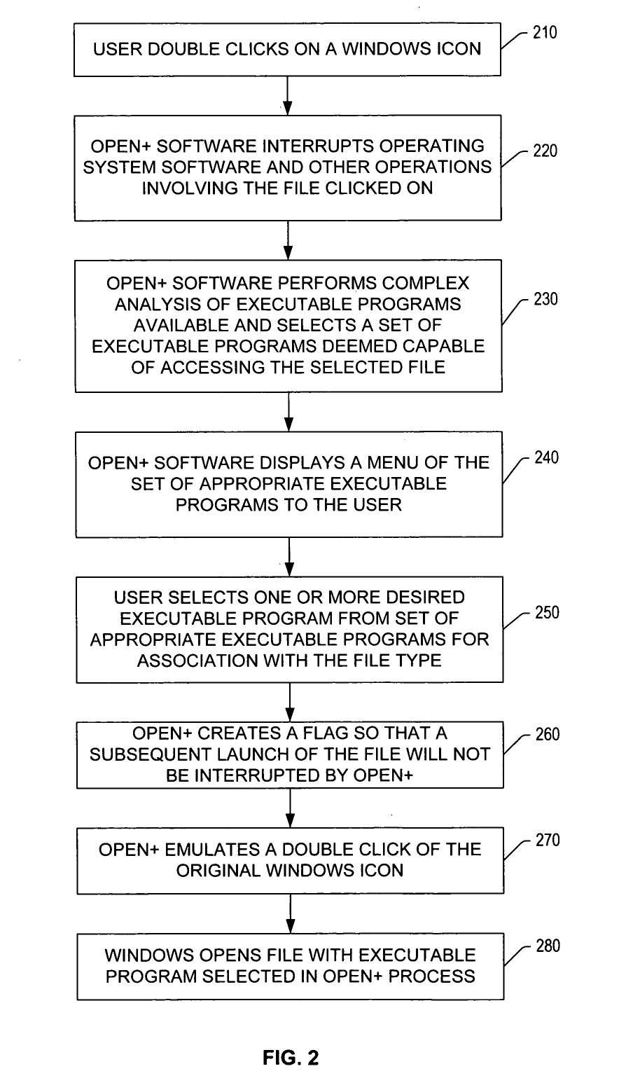

FIG. 2 shows a simplified flow chart diagram of a process for selecting a software application for use in opening a selected data file at 210 in accordance with one embodiment of the present invention. The process begins at a step 210 in which a user double clicks a Windows icon. In accordance with alternative embodiment of the present invention this step may be substituted with automated commands, remote functions, or other mechanisms having an effect similar to a command to open or otherwise access a selected data file.

In a step 220 the Open+ software interrupts the computer operating system and possibly other operations involving the selected data file. In accordance with a preferred embodiment of the present invention the Open+ software in no way alters operating system registry or any other portion of the operating system. In step 230 the Open+ application performs a complex analysis of executable programs available within system permanent storage device and selects a set of executable programs deemed capable of accessing the selected data file. In a preferred embodiment this is accomplished by collecting data from the selected data file and scanning the hard disk, or any available storage devices for existing data and executable files. A complex algorithm is performed to determine which of these computer programs are capable of interacting with the data file type.

The process continues with a step 240 at which the Open+ software displays a menu of the set of appropriate computer programs for accessing the selected data file type. In a step 250 the user selects one or more of software applications displayed for association with the data file and may select one for default use with the data file. In subsequent attempts to open the file the associated files will be displayed instead of a full search being conducted, and if a default is selected then no applications will be displayed.

In a step 260 the software of the present invention creates a flag that tells Open+ not to interrupt a subsequent launch of the data file. This can be accomplished in various ways but should prevent the next activation of Open+ in relation to the selected data file, but not other future attempts to access the selected data file.

In a step 270 the software of the present invention emulates a double-click, or other activation method for the selected data file. The operating system then opens the selected data file with the selected software application.

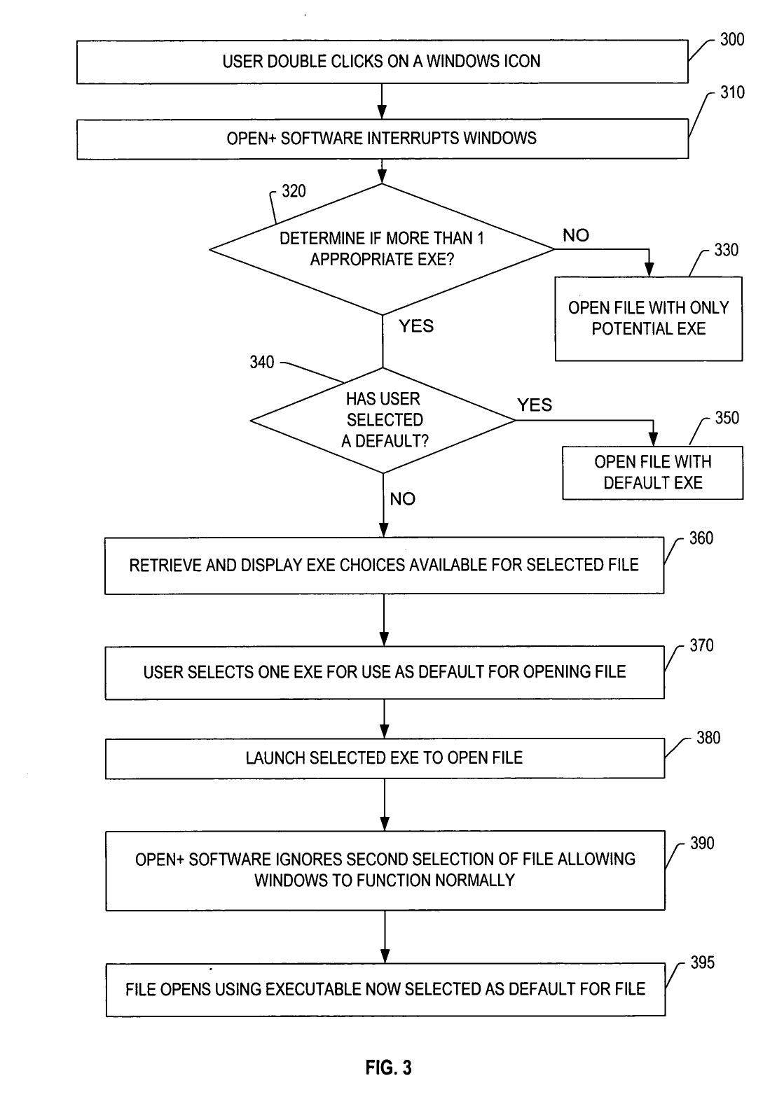

FIG. 3 shows a simplified flow chart diagram of another process for selecting a software application for use in opening a selected data file at 300 in accordance with another embodiment of the present invention. The process begins at a step 300 in which a user double clicks a Windows icon. In accordance with alternative embodiment of the present invention this step may be substituted with automated commands, remote functions, or other mechanisms having an effect similar to a command to open or otherwise access a selected data file.

In a step 310 the Open+ software interrupts the computer operating system and possibly other operations involving the selected data file. In accordance with a preferred embodiment of the present invention the Open+ software in no way alters operating system registry or any other portion of the operating system. In step 320 the Open+ application determines if more than 1 executable program exists appropriate for opening the selected data file associated with the Windows icon. In accordance with a preferred embodiment of the present invention a periodic scan of the hard disk, or any available storage devices for existing applications and executable files is performed at some regular interval such as monthly. A file is created which stores information on all exe files, including version information, location and internal name (for display purposes). In step 320 the Open+ software checks this file to determine what .exe files are capable of opening the selected file. If only one executable file is capable of opening the selected data file then the computer opens the data file with that executable file at step 330.

If in step 320 more than one appropriate executable file is found the process continues to a step 340. At step 340 the system determines whether a default executable file has been previously selected for the desired data file. If so the file is opened with that default executable file at a step 350.

If in step 320 it was determined that no default had been selected the process would continue to a step 360. At step 360 the software of the present invention would retrieve and display all executable files available for use with the selected data file. The user would then be prompted to select one of the executable files for use as a default for opening the selected data file at step 370. Then in a step 380 the data file would be launched using the selected executable file. In step 390 the launch of step 380 is ignored by the Open+ software, allowing the operating system to function as if Open+ was not operating on the computer system.

In step 395 the data file is opened normally using the executable file now selected as a default for use with the data file.

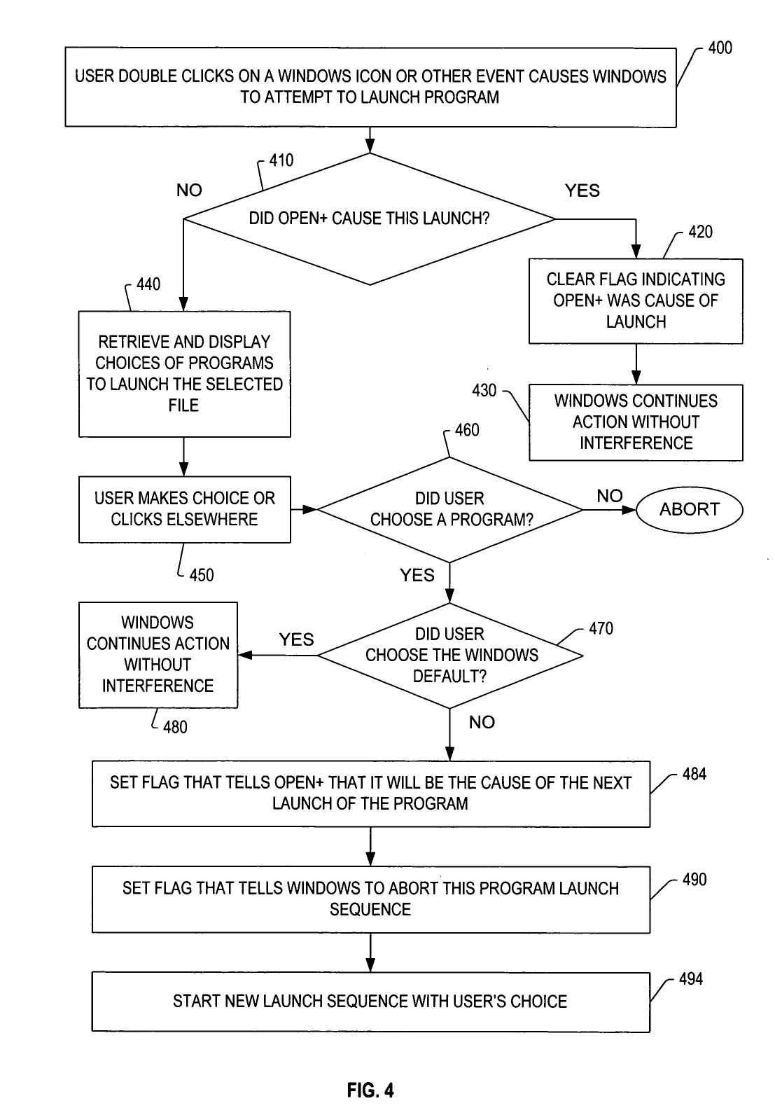

FIG. 4 shows a simplified flow chart diagram of alternative process for opening a selected data file with a selected software application at 400 in accordance with another embodiment of the present invention. The process begins at a step 400 in which a user attempts to launch a selected program, generally by double clicking a Windows icon associated with that program. In accordance with alternative embodiment of the present invention this step may be substituted with automated commands, remote functions, or other mechanisms having an effect similar to a command to launch or otherwise access a selected computer program.

In a step 410 the software of the present invention determines whether it caused the attempted launch in step 400. If it did cause this attempted launch the process continues to a step 420 at which any flags or indicators indicating that the launch was caused by the Open+ software are cleared, removed or otherwise disabled. Then in a step 430 the operating system continues without interruption in launching the selected program.

If in step 410 the Open+ software was found not to have caused the launch attempt, then the process continues to step 440 at which the Open+ application retrieves and displays choices of programs to use in launching the selected program. Then in step 450 the user makes a choice by clicking on one of the menu items or taking some other action.

At a step 460 it is determined whether the user chose a menu item. If the user did not select one of the menu items then the launch operation is aborted. If in step 460 it is determined that a choice was made the process continues to step 470 at which it is determined whether the user selected the Windows default application. If the Windows default is chosen the process continues to step 480 at which Windows is allowed to continue to launch the selected program without interference.

If at step 470 it is determined that the user chose an application other than the Windows default then the process goes to a step 484. At step 484 a flag or other indicator is set that tells the Open+ software that it will be the cause of the next launch of the program. Then in a step 490 a flag is set that tells the operating system to abort this program launch sequence. In accordance with alternative embodiments operating systems may include Windows, Linux, Sun, Mac OS, etc. In accordance with a preferred embodiment of the present invention the software of the present invention will be designed to function on all known operating systems.

Finally in step 494 a new launch sequence is initiated using the users selected application to launch the selected program.

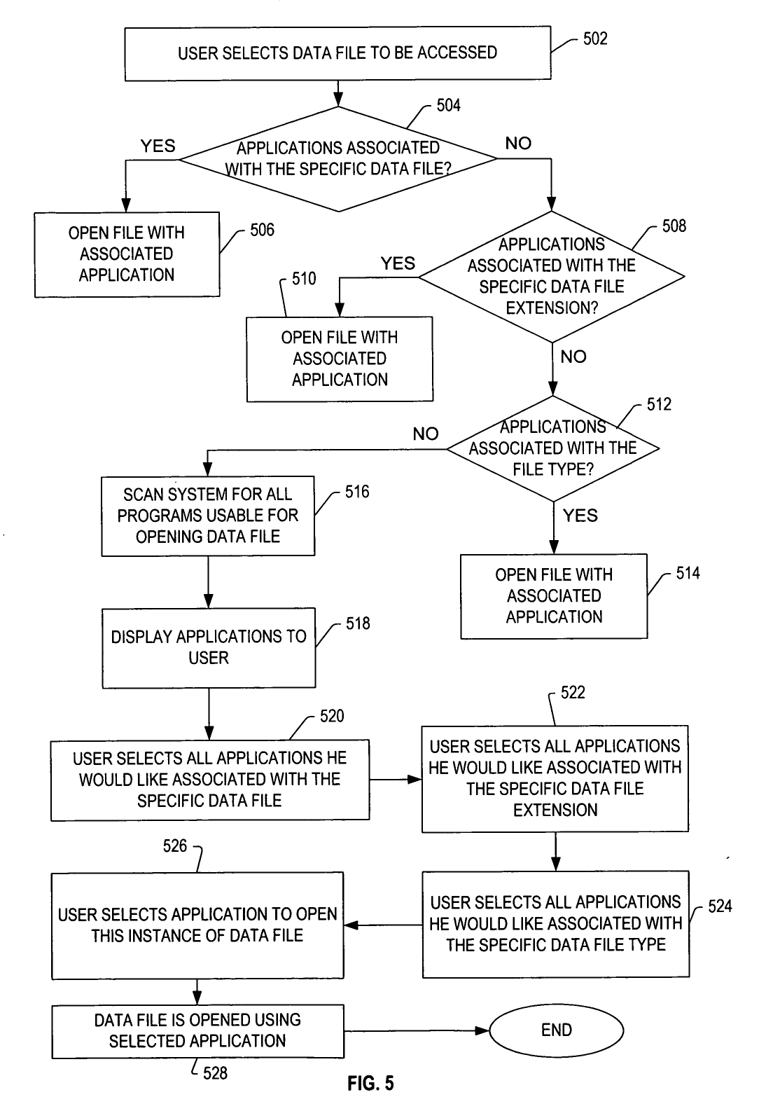

FIG. 5 shows a simplified flow chart diagram of a process for associating selected data file with selected software application at 500 in accordance with a preferred embodiment of the present invention. The process begins at a step 502 in which a user selects a data file. In a preferred embodiment this will generally occur when a file is double clicked in a Windows environment. In accordance with alternative embodiment of the present invention this step may be substituted with automated commands, remote functions, or other mechanisms.

In a step 504 the software of the present invention determines whether there exists an application which is specifically associated with the particular data file. For example, the user may have previously associated a legal document with an obscure word processor application in order to maintain originality of the document. In such a case the user would want to always open the specific document with that obscure word processor application, though he may want to open other archaic documents with a modern word processor document.

If a specific association for the file exists then the file is opened with that application in step 506. In accordance with the above example the legal document would be opened with the obscure word processor application. If multiple such associations exist the user is prompted to choose which associated application should be used in this launching of the selected data file.

If no specific association for the file exists then a check is made for applications associated with the extension of the data file at step 508. For example a tiff file would be opened with the application associated with all .tiff files. If such a specific association exists then the file is opened with that associated application at step 510. If multiple such associations exist the user is prompted to choose which associated application should be used in this launching of the selected data file.

If no association is indicated for the file extension the process continues to step 512 where a check is made for associations for the file type. For example the Open+ software may be set such that all text documents are opened with the latest version of MS Word. If such an association exists the file is opened with that application at step 514. If multiple such associations exist the user is prompted to choose which associated application should be used in this launching of the selected data file.

If no such association exists the system is scanned for all applications existing which can be used to access the selected data file at step 516. All such applications are then displayed to the user at 518. In step 520 the user selects all applications he would like associated with the specific data file. In step 522 the user selects all applications he would like associated with the specific file extension. For example .mpg, .vsd, .tiff, .jpg, .pdf, etc. In step 524 the user selects all applications he would like associated with the data file type. For example, types may include video, image, text, audio, etc. Then in a step 526 the user selects application used to open this instance of the launching of the data file from all associated data files. In step 528 the data file is opened using the selected application. The above flow diagram is very general and is intended only as a basic guideline for a multitude of different methods for associating various applications with various categories of data file.

In accordance with a preferred embodiment it is also possible to link applications such that any time that one application comes up in a menu as being associated with a file the linked application also is listed in the menu. In this way Open+ with a single user action, a user can associate “Many Programs with Many Extensions”.

In accordance with another preferred embodiment associations are set up in a branch organization such that applications can be grouped under virtually any topic. Further, file types can also be grouped by virtually any measurable quantity. In such a branch organization associations can be changed by dragging and dropping applications, application types and file types.

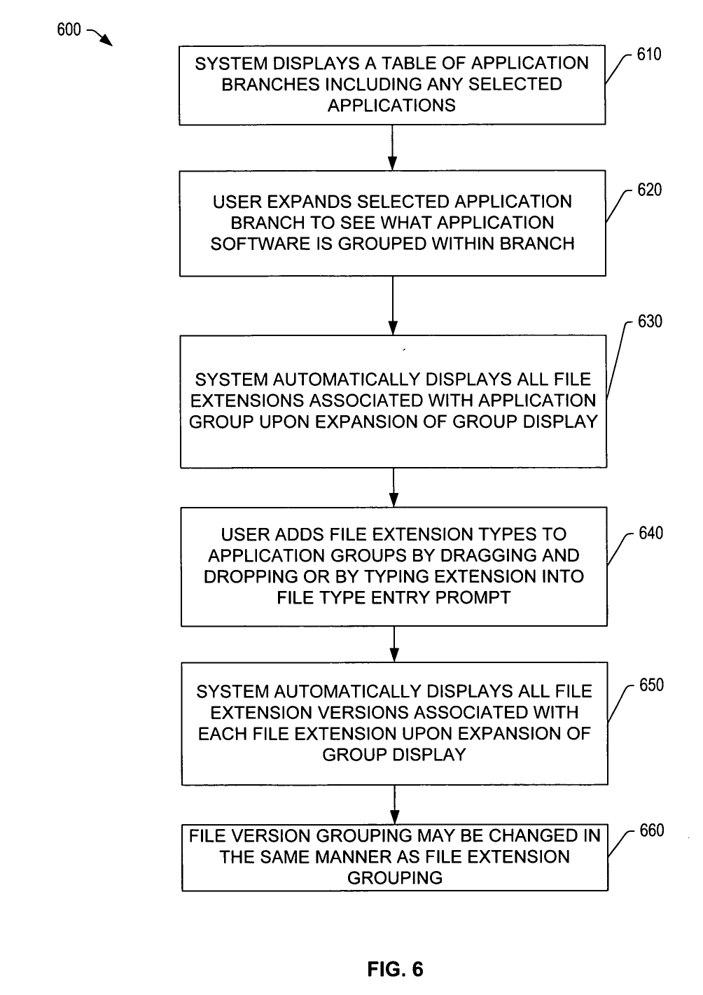

FIG. 6. illustrates a simplified flow chart diagram of a process for associating selected file extensions with selected software application groups at 600 in accordance with a preferred embodiment of the present invention. In a step 610 the Open+ software interface displays a table of application branches including all applications on a computer system permanent storage device. In step 620 a user expands a selected application branch to see what application software is grouped within the branch. In a preferred embodiment this branching is graphically displayed in a manner similar to the graphic display of branching within the MS Outlook program.

In a step 630 the Open+ interface automatically displays all file extension encompassed within the selected application branch just expanded. In a step 640 the Open+ interface also displays all file extension versions associated with the file extensions.

In step 650 the user adds file extension types to a selected application group branch by dragging and dropping or by typing extension information into a file type entry field. In 660 file version grouping is changed in the same manner as file extension grouping. In accordance with one embodiment of the present invention any XXX characters may be used to create a custom extension.

The following table shows an example of the display described in FIG. 6:

Association List
Non-Associated
Graphic
Web Master
HTML
Programs
Notepad
Extensions
.htm
.html

Extension List

| Extension | Association |
|---|---|
| .h | hfile |
| .hdb | NeroHDB |
| .hxx | Winzip |
| .hxz | Winzip |
| .html | MozillaHTML |
| .htm | MozillaHTML |
| .htw | htmlfile |
| .htt | htmlfile |
| .wdd | WinWord97 |

In accordance with the present invention virtually any grouping of extensions and applications is possible. When only one application is associated with an extension it effectively becomes a default application for the extension, otherwise a menu will give a user all associated choices.

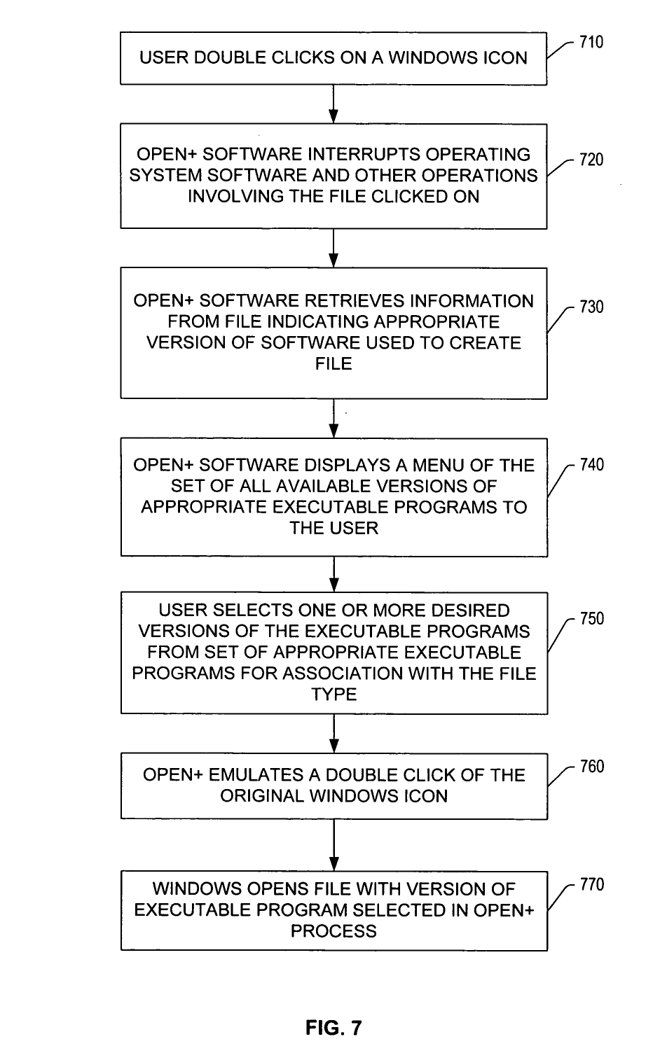

FIG. 7 shows a simplified flow chart diagram of a process for associating a desired version of a particular software application for use in opening a selected data file at 710 in accordance with one embodiment of the present invention. The process begins at a step 710 in which a user double clicks a Windows icon. In accordance with alternative embodiment of the present invention this step may be substituted with automated commands, remote functions, or other mechanisms having an effect similar to a command to open or otherwise access a selected data file.

In a step 720 the Open+ software interrupts the computer operating system and possibly other operations involving the selected data file. In accordance with a preferred embodiment of the present invention the Open+ software in no way alters operating system registries or any other portion of the operating system. In step 730 the Open+ application retrieves information from the selected data file including information regarding the version of software application used to create and last modify the selected data file.

The process continues with a step 740 at which the Open+ software displays a menu of the set of all available versions of appropriate software applications for accessing the selected data file type. In a step 750 the user selects one or more of software application versions displayed for association with the data file and may select one for default use with the data file. In accordance with an alternative embodiment the version used to originally create the file and/or last used to modify the file may be highlighted or otherwise distinguished from other choices. In accordance with a preferred embodiment the user may also select a choice for use as an automatic default software application to always be used in opening the selected data file. In subsequent attempts to open the file the associated files will be, and if a default is selected then no applications will be displayed.

In a step 760 the software of the present invention emulates a double-click, or other activation method for the selected data file. The operating system then opens the selected data file with the selected software application. Finally in step 770 Windows opens the selected data file with the version of the software application chosen by the user in step 750. This allows users to access data files using any version of application software they wish. For example, during tax season a tax professional may receive numerous QuickBooks files from their clients that range through 3 to 5 years and various versions of QuickBooks from QuickBooks 2003 to QuickBooks 99. Of course when the accountant clicks on the file Windows would will automatically launch the file in the latest version that is installed. Typically, that will be the most recently released version. Occasionally they may even hurriedly or unintentionally upgrade the clients data files and later have to negotiate with the client to upgrade the clients version, or redo the work already done.

With Capio Open+ when the accountant clicks on the file they will get a list of all versions of QuickBooks available in hard storage. Then, all the accountant has to do is select the right version from the list presented. There is no need for file-type conversion, and no danger of unexpected behavior based on an application/data mis-match.

Another example would be web developers using different versions of various web browsers. People who visit web sites can choose between several major varieties of browser, and each variety has many versions, each with different capabilities and limitations. Web developers who want the widest possible audience must test their pages against several versions of the various browsers. In addition to the browser proliferation, developers will typically edit the web page in both a text editor and an HTML editor, depending on the stage of development of the web page. All of this means that a web developer or web master can easily end up using many programs to develop and display the same file. With an average web site containing scores of pages, being able to easily choose the right program at teach step of development is a significant time and money saving plus for developers. Capio Open+ provides just such a tool.

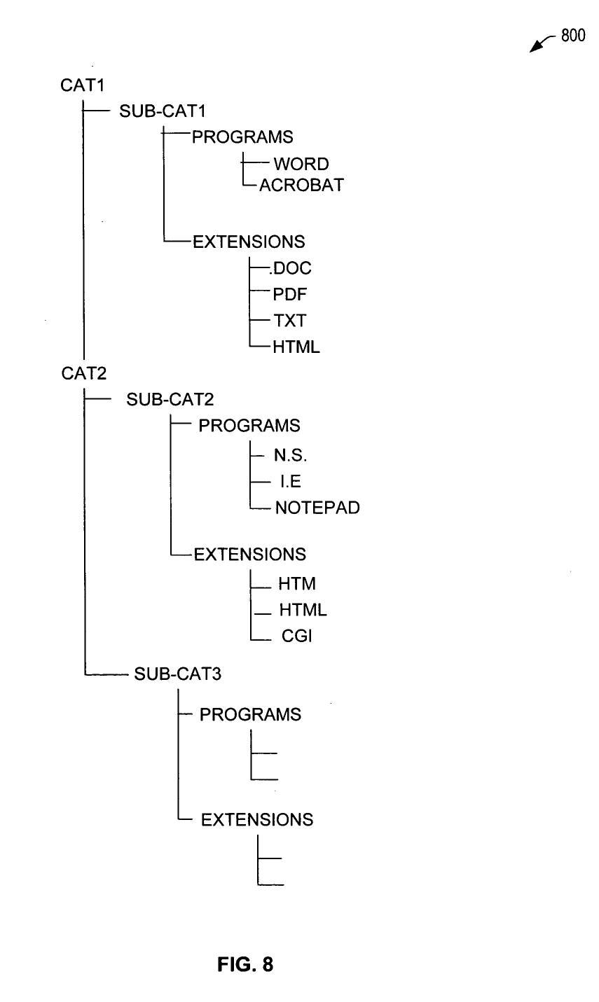

FIG. 8 shows a hierarchical relationship of groupings of applications and extensions at 800 in accordance with one embodiment of the present invention. In accordance with a preferred embodiment any category or subcategory can be turned on or off with a single user action. In accordance with the embodiment illustrated in FIG. 8 whenever a file is selected for opening a menu including all associated programs is displayed. In a case in which a category is off, no associations of the “off” category are displayed unless also included in an “on” category. In accordance with a preferred embodiment of the present invention any number of categories may be created by a user, and each category may have an unlimited number of sub-categories.

The foregoing examples illustrate certain exemplary embodiments of the invention from which other embodiments, variations, and modifications will be apparent to those skilled in the art. The invention should therefore not be limited to the particular embodiments discussed above, but rather is defined by the following claims.

What is claimed is:

1. A computer implemented method for associating one or more computer software applications with one or more computer data files on a computer system comprising the acts of:
providing a computer system, wherein said computer system includes at least one permanent storage device containing at least a portion of at least one data file containing data;
selecting said data file;
searching said at least one permanent storage device for one or more computer software applications potentially usable in conjunction with said selected data file, wherein said searching is at least partially responsive to said data;
selecting at least one of said one or more computer software applications for use in accessing said data file; and
accessing at least a portion of said data file using said at least one selected computer software applications.

2. A method as recited in claim 1, wherein said data includes file extension information.

3. A method as recited in claim 1, further comprising:
selecting at least one of said one or more computer software applications to be associated with said data file such that said associated computer software applications will be displayed in response to future attempts to access said data file.

4. A method as recited in claim 1, further comprising the acts of:
searching said permanent storage device for one or more versions of said computer software applications;
displaying said versions;
associating one or more of said versions with said data file in response to a user selection.

5. A method as recited in claim 3, further comprising the acts of:
associating said one or more computer software applications to an application group such that all file types associated with any one member of said application group are also associated with any other member of said application group.

6. A method as recited in claim 5, including associating said application group to a master application group, wherein said master group includes a plurality of sub-groups, and wherein each of said sub-groups includes at least one associated application file.

7. A method as recited in claim 1, wherein said at least one data file containing data includes a file extension.

8. A computer implemented method as recited in claim 7, further comprising;
wherein said selected data file is associated with at least one computer software application by assigning said selected data file a file extension associated with said at least one computer software application.

9. A method as recited in claim 8, including providing an association map to at least one user wherein said association map includes a mapping of each said file extension to each said associated computer software application enabling said at least one user to alter said association such that said file extension is associated with an additional computer software application.

10. A method as recited in claim 9, wherein said user is enabled to select a computer software application for use in opening said data file from any computer software applications associated with said file extension.

11. A computer implemented method for associating computer data files with computer software applications comprising the acts of:
providing a computer system including one or more computer devices, each including one or more microprocessor devices, wherein said computer system includes at least one permanent storage device containing at least a portion of at least one data file containing data indicating a file type;
receiving at least one command selecting said data file;
displaying one or more computer software applications potentially usable in conjunction with said selected data file;
selecting at least one of said one or more computer software applications for association with said file type; and
accessing at least a portion of said selected data file using at least one of said selected associated computer software applications.

12. The computer implemented method of claim 11 further comprising:
grouping said selected associated computer software applications with an application group such that any other computer software application associated included within said application group is also associated with said selected file type.

13. The computer implemented method of claim 11 further comprising assigning a file extension to said selected data file, wherein said assignment of a file extension creates an association between said file extension and a first application and a second application.

14. The computer implemented method of claim 13 further comprising associating at least one second computer software application to said at least one first computer software application, wherein said association of said at least one first and said at least one second computer software application automatically associates said file extension with said second computer software application such that launching said selected data file enables a user to selected said at least one second computer software application as an available associated computer software application useable in opening said selected data file.

15. The computer implemented method of claim 13 further comprising displaying program version information and a corresponding program name for enabling a user to select between versions of a program.

16. The computer implemented method of claim 15 further comprising indicating a correct version of said program, wherein said correct version corresponds to a version of the program used to create said selected data file.

17. The computer implemented method of claim 11 further comprising enabling a user to abort a program file launch process by taking an action other than selecting at least one application.

18. The computer implemented method of claim 11 further comprising enabling a user to create an alias for any computer program located on said computer system.

19. The computer implemented method of claim 13 further comprising:
grouping a first set of applications with first set of file extensions application group;
grouping a second set of applications with a second set of file extensions; and
enabling a user to disable any group of applications and extensions with a single user action such that any associations between members of the group are disabled.

20. A computer implemented method for accessing one or more data files comprising the acts of:
providing a computer system including one or more computer devices including one or more microprocessor devices, wherein said computer system includes at least one permanent storage device containing at least a portion of at least one data file containing data;
receiving at least one command selecting said data file;
searching said at least one permanent storage device for one or more software programs potentially usable in conjunction with said selected data file, wherein said searching is at least partially responsive to said data;
selecting at least one of said one or more software programs for use in accessing said data file; and
accessing at least a portion of said data file using at least one of said software programs.
